(19) United States
(12) Patent Application Publication
(10) Pub. No.: US 2009/0213704 A1
(43) Pub. Date: Aug. 27, 2009

(54) OPTICAL DISK APPARATUS AND SERVO CONTROL METHOD

(75) Inventor: Mikio Yamamuro, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/393,557

(22) Filed: Feb. 26, 2009

(30) Foreign Application Priority Data
Feb. 27, 2008 (JP) 2008-046182

(51) Int. Cl. G11B 7/00; G11B 20/10

(52) U.S. Cl. 369/44.29; 369/47.14; G9B/7; G9B/20.009

(57) ABSTRACT

According to one embodiment, an optical disk apparatus comprises an optical pickup which irradiates an optical disk with a light beam and receives reflected light from the disk, and a driving module which drives the pickup. The driving module includes an error detector which detects a tracking servo error with respect to a recording track on the disk from an output signal of the pickup and a tracking control module which performs tracking control over the pickup based on a servo error signal from the error detector. The control module is configured to temporarily set a tracking servo to an OFF state upon switching from a reproduction state to a recording state, measure an offset of the servo error signal, perform offset correction for the offset with respect to the servo error signal, and restore the tracking servo to an ON state after the offset correction.

### CROSS-REFERENCE TO RELATED APPLICATIONS

This application is based upon and claims the benefit of priority from Japanese Patent Application No. 2008-046182, filed Feb. 27, 2008, the entire contents of which are incorporated herein by reference.

### BACKGROUND

1. Field

One embodiment of the present invention relates to an optical disk apparatus and a servo control method that control tracking or focusing of an optical pickup which irradiates a recording surface of an optical disk with a light beam based on a servo scheme.

2. Description of the Related Art

An optical disk apparatus generally receives reflected light from an optical disk by an optical pickup, detects an error of a tracking servo or a focusing servo from an output signal from this optical pickup as a servo error signal, and determines a state of the tracking servo or the focusing servo based on a corresponding servo error signal. That is, the tracking servo or the focusing servo is turned on when the corresponding servo error signal is at a tolerance level, and turned off when this signal exceeds the tolerance level.

In such an optical disk apparatus, the servo error signal is dependent on a recording/reproduction performance of the apparatus. There has been conventionally known a technology of performing offset measurement that is not dependent on the recording/reproduction performance while assuring stability of focal point position control for a light beam by effecting offset correction in a state where the light beam is applied and effecting offset correction by control only in a stabilized state where the servo is stabilized (see, e.g., JP-A 2004-287168 (KOKAI)).

Meanwhile, when the optical disk apparatus is switched to a recording state from a reproduction state, a temporal shift of the servo error signal occurs as an offset mainly caused due to an increase in a light beam power. Even if track catching and just focusing have succeeded in the reproduction state, when the tracking servo or the focusing serve is effective (ON) in this switching, a displacement of an irradiating position or a focal point position of the light beam occurs at the moment this offset returns to zero with a time that is dependent on a response time of a servo system.

However, since JP-A 2004-287168 (KOKAI) adopts a scheme of performing detection of an offset by holding the servo in the stabilized state, an offset that is produced in switching from the reproduction state to the recording state cannot be corrected.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a structure of an optical disk apparatus according to an embodiment of the present invention;

FIG. 2 is an exemplary block diagram showing a detailed structure of a tracking control circuit depicted in FIG. 1;

FIG. 3 is an exemplary block diagram showing a structure of a focusing control circuit depicted in FIG. 1 in detail;

FIG. 4 is an exemplary flowchart showing recording processing executed in the optical disk apparatus depicted in FIG. 1;

FIG. 5 is a diagram showing an example of a signal waveform and a tracking state obtained when the optical disk apparatus is switched from a reproduction state to a recording state without providing an offset correcting module depicted in FIG. 2;

FIG. 6 is a diagram showing an example of a signal waveform and a tracking state obtained when the offset correcting module depicted in FIG. 2 is provided and the optical disk apparatus is switched from the reproduction state to the recording state;

FIG. 7 is a diagram showing an example of a signal waveform and a focusing state obtained when the optical disk apparatus is switched from the reproduction state to the recording state without providing an offset correcting module depicted in FIG. 3; and

FIG. 8 is a diagram showing an example of a signal waveform and a focusing state obtained when the offset correcting module depicted in FIG. 2 is provided and the optical disk apparatus is switched from the reproduction state to the recording state.

### DETAILED DESCRIPTION

Various embodiments according to the invention will be described hereinafter with reference to the accompanying drawings.

According to one embodiment of the present invention, there is provided an optical disk apparatus comprising: an optical pickup which irradiates a recording surface of an optical disk with a light beam selectively set to one of a reproduction power and a recording power and receives reflected light from the recording surface; and a driving module which drives the optical pickup, wherein the driving module includes an error detector which detects a tracking servo error with respect to a recording track on the recording surface from an output signal of the optical pickup and a tracking control module which performs tracking control over the optical pickup based on a tracking servo error signal obtained from the error detector, and the tracking control module is configured to temporarily set a tracking servo to an OFF state upon switching from a reproduction state to a recording state, measure an offset of the tracking servo error signal produced due to the switching, perform offset correction for the offset with respect to the tracking servo error signal, and restore the tracking servo to an ON state after the offset correction.

According to one embodiment of the present invention, there is provided an optical disk apparatus comprising: an optical pickup which irradiates a recording surface of an optical disk with a light beam selectively set to one of a reproduction power and a recording power and receives reflected light from the recording surface; and a driving module which drives the optical pickup, wherein the driving module includes an error detector which detects a focusing servo error with respect to the recording surface from an output signal of the optical pickup and a focusing control module which performs focusing control over the optical pickup based on a focusing servo error signal obtained from the error detector, and the focusing control module is configured to temporarily set a focusing servo to an OFF state upon switching from a reproduction state to a recording state, measure an offset of the focusing servo error signal produced due to the switching, perform offset correction for the offset with respect to the focusing servo error signal, and restore the focusing servo to an ON state after the offset correction.

According to one embodiment of the present invention, there is provided a servo control method of an optical disk apparatus which comprises an optical pickup which irradiates a recording surface of an optical disk with a light beam selectively set to one of a reproduction power and a recording power and receives reflected light from the recording surface, and a driving module which drives the optical pickup, wherein the driving module includes an error detector which detects a tracking servo error with respect to a recording track on the recording surface and a focusing servo error with respect to the recording surface from an output signal of the optical pickup, and a control module which performs at least one of tracking control and focusing control over the optical pickup based on each servo error signal obtained from the error detector, the method comprising: temporarily setting a servo to an OFF state upon switching from a reproduction state to a recording state; measuring an offset of each servo error signal caused due to the switching; performing offset correction for the offset with respect to each servo error signal; and restoring the servo to an ON state after the offset correction.

According to these optical disk apparatus and servo control method, the tracking servo or the focusing servo is temporarily set to the OFF state upon switching from the reproduction state to the recording state, an offset of the servo error signal produced due to this switching is measured, offset correction for this offset is carried out with respect to the servo error signal, and the tracking servo or the focusing servo is restored to the ON state after this offset correction. That is, since a step produced in the servo error signal due to switching from the reproduction state to the recording state is canceled out by this offset correction, stable servo control can be executed with respect to the optical pickup in this switching.

An optical disk apparatus according to an embodiment of the present invention will now be explained hereinafter.

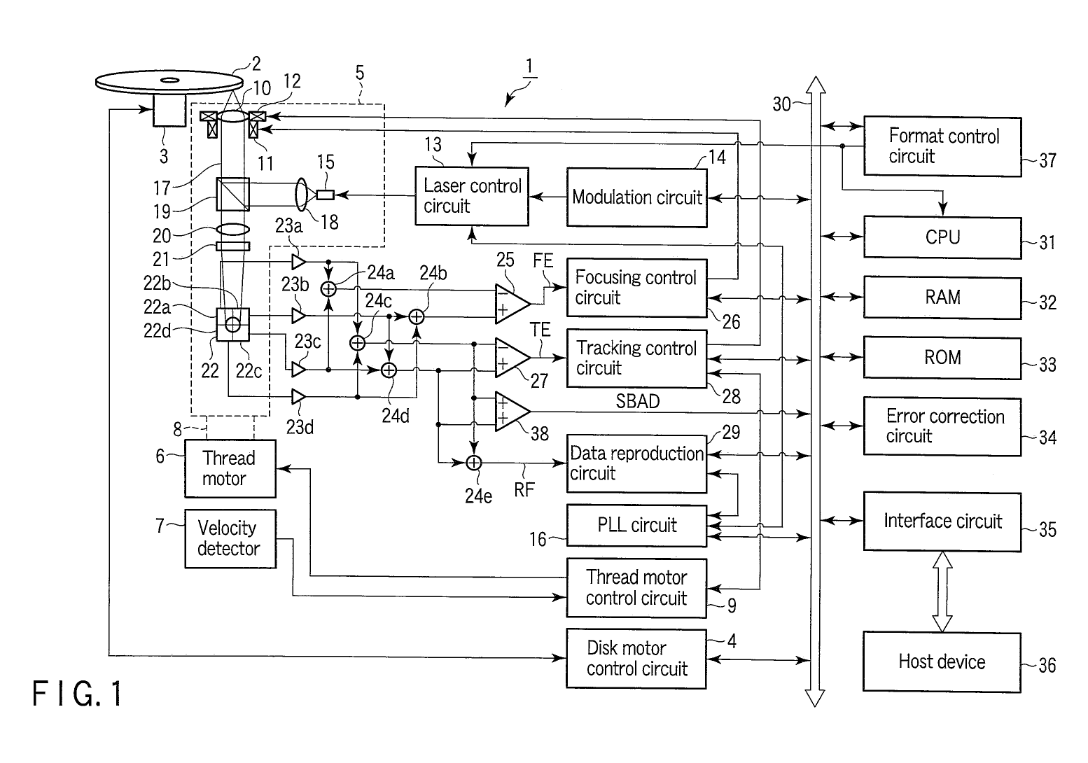

FIG. 1 shows a structure of this optical disk apparatus 1. An optical disk 2 is an optical disk on which user data can be recorded. The optical disk 2 has a recording track like a land track or a group track spirally formed on a recording surface thereof, and it is rotated by a disk motor 3. This disk motor 3 is controlled by a disk motor control circuit 4. An optical pickup 5 performs recording and reproduction of data with respect to the optical disk 2. The optical pickup 5 irradiates the recording surface of the optical disk with a light beam which is selectively set to one of a reproduction power and a recording power, and receives reflected light from this recording surface. The optical pickup 5 is driven by the following driving module. That is, this optical pickup 5 is coupled with a thread motor 6 through a coupling module 8 including a gear and others, and can be moved in a radial direction of the optical disk 2 by a driving force of this thread motor 6. The thread motor 6 is controlled by a thread motor control circuit 9. The thread motor control circuit 9 is connected with a velocity detector 7 that detects a velocity of the optical pickup 5, and drives the thread motor 6 based on a velocity signal as a detection result from this velocity detector 7 to move the optical pickup 5. The optical pickup 5 has an object lens 10 that is movably supported by a non-illustrated wire or leaf spring. This object lens 10 can move in a focusing direction (an optical axis direction of the lens) by a focus actuator 11, and can also move in a tracking direction (a direction orthogonal to an optical axis of the lens) crossing the recording track by a tracking actuator 12.

A modulation circuit 14 performs, e.g., 8-14 modulation (EFM) for a DVD-type recording medium with respect to data supplied from a host device 36 via an interface circuit 36 at the time of recording (at the time of forming a mark), and supplies EFM data obtained by this modulation to a laser control circuit 13. The laser control circuit 13 supplies a recording signal based on this EFM data to a laser diode 15. The laser diode 15 generates a laser beam as a light beam in accordance with this recording signal. The optical disk 2 is irradiated with the light beam through a collimator lens 18, a half prism 19, and the object lens 10.

Reflected light from the optical disk 2 is led to a photodetector 22 through the object lens 10, the half prism 19, and a condenser lens 20, and a cylindrical lens 21. The photodetector 22 is formed of four split light receiving modules 22a to 22d. Output signals from these light receiving modules 22a to 22d are supplied to a first differential amplifier 25 and a second differential amplifier 27 via respective current-voltage (I-V) conversion amplifiers 23a to 23d and adders 24a to 24d. The amplifiers 23a to 23d, the adders 24a to 24d, and the first differential amplifier 25 constitute a focusing servo error detector that detects a focusing servo error with respect to the recording surface from an output signal of the optical pickup 5, and the amplifiers 23a to 23d, the adders 24a to 24d, and the second differential amplifier 27 constitute a tracking servo error detector that detest a tracking servo error with respect to the recording track on the recording surface from an output signal of the optical pickup 5.

The first differential amplifier 25 outputs a focusing servo error signal FE corresponding to a difference between both output signals from the adders 24a and 24b. A focusing control circuit 26 outputs a servo signal to the focus actuator 11 based on the focusing servo error signal FE from the first differential amplifier 25. The focus actuator 11 drives the object lens 10 in accordance with the servo signal from the focusing control circuit 26, thereby constantly matching a just focal point position of a light beam with the recording surface of the optical disk 2.

The second differential amplifier 27 outputs a tracking servo error signal TE corresponding to a different between output signals from the adders 24c and 24d. A tracking control circuit 28 outputs a servo signal to the tracking actuator 12 based on the tracking servo error signal TE from the second differential amplifier 27. The tracking actuator 12 drives the object lens 10 in accordance with the servo signal from the tracking control circuit 28, thereby matching a central position of the object lens 10 with the track on the recording surface of the optical disk 2. The tracking control circuit 28 also outputs the servo signal to the thread motor control circuit 9. The thread motor control circuit 9 drives the thread motor 6 based on the tracking servo error signal TE to move the optical pickup 5 in the radial direction of the optical disk 2 in such a manner that the central position of the object lens 10 gets closer to the track.

The adder 24e outputs a sum signal of output signals from the light receiving modules 22a to 22d as the photodetector 22, i.e., an addition result of output signals from the adders 24c and 24d to a data reproduction circuit 29 as a reproduction signal RF. A change in reflectivity from a pit (recorded data) recorded in the optical disk 2 is reflected in this reproduction signal RF. The data reproduction circuit 29 reproduces the recorded data based on a reproduction clock signal from a PLL circuit 16. The PLL circuit 16 detects a data phase from the reproduction signal RF, and sets this data phase to a phase locked state to obtain a reproduction clock signal. Reproduced data reproduced by the data reproduction circuit 29 is subjected to error correction using an error correction code given thereto by an error correction circuit 34, and then output to the host device 36 through an interface circuit 35. A format control circuit 37 turns on a light gating signal for the laser control circuit 13 at the time of recording, and performs control in such a manner that a power of a light beam generated as a laser beam from the laser diode 15 is changed from a reproduction power to a recording power.

The disk motor control circuit 4, the thread motor control circuit 9, the laser control circuit 13, the modulation circuit 14, the PLL circuit 16, the data reproduction circuit 29, the focusing control circuit 26, and the tracking control circuit 28 are constituted as, e.g., a single LSI chip and controlled by a CPU 31 through a bus 30. The CPU 31 controls the entire optical disk apparatus 1 in accordance with an operation command supplied from the host device 36 through the interface circuit 35. Further, the CPU 31 uses an RAM 32 as a work area, and carries out a control operation in accordance with a control program recorded in an ROM 33.

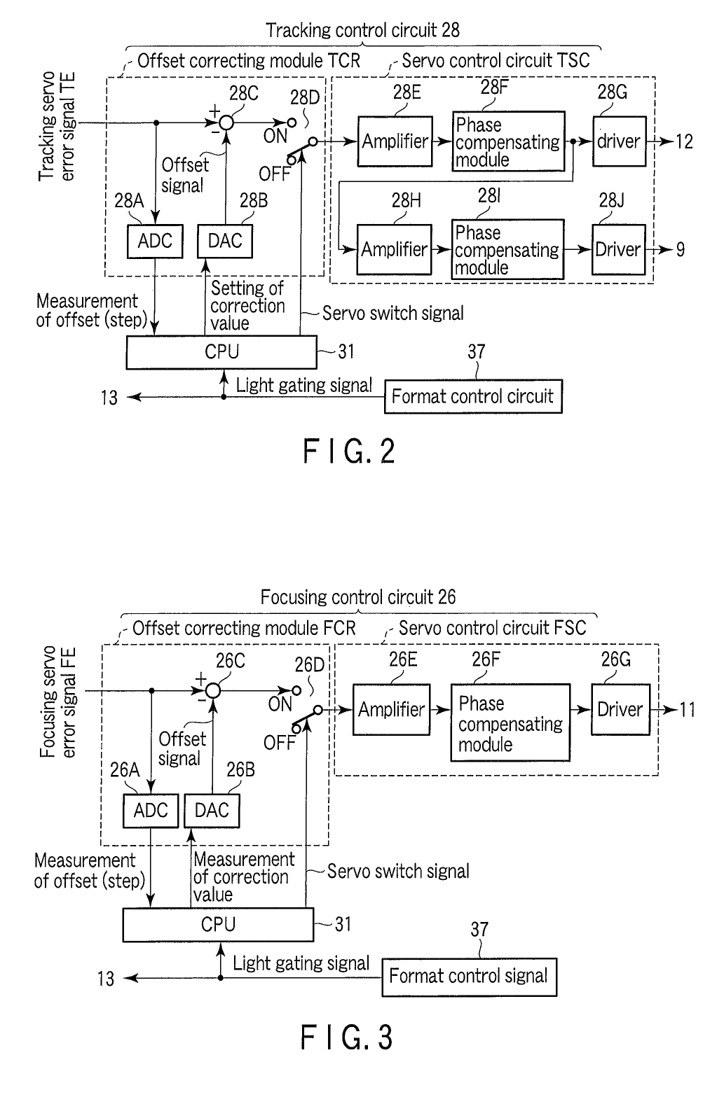

FIG. 2 shows a structure of the tracking control circuit 28 in detail. This tracking control circuit 28 includes an offset correcting module TCR that performs offset correction with respect to the tracking servo error signal TE from the second differential amplifier 27 and a servo control circuit TSC that generates a servo signal for the tracking actuator 12 and a servo signal for the thread motor control circuit 9 based on an output signal from this offset correcting module TCR. The offset correcting module TCR has an AD converter (ADC) 28A that converts the tracking servo error signal TE from an analog form into a digital form and outputs the converted signal to the CPU 31, a DA converter (DAC) 28B that converts an offset correction value from the CPU 31 into an analog form from a digital form and outputs the converted signal as an offset signal, an adder 28C that corrects the tracking servo error signal TE from the second differential amplifier 27 by using the offset signal, and a switch element 28D that selectively outputs the tracking servo error signal TE as a result of this correction based on control of a servo switch signal from the CPU 31. The servo control circuit TSC has an amplifier 28E that amplifies the tracking servo error signal TE from the switch element 28D, a phase compensating module 28F that performs phase compensation with respect to an output signal from the amplifier 28E, a driver 28G that outputs an output signal from the phase compensating module 28F to the tracking actuator 12 as a servo signal, an amplifier 28H that amplifies an output signal from this phase compensating module 28F, a phase compensating module 28I that carries out phase compensation with respect to an output signal from this amplifier 28H, and a driver 28J that outputs an output signal from this phase compensating module 28I to the thread motor control circuit 9 as a servo signal.

That is, the CPU 31 and both the offset correcting module TCR and the servo control circuit TSC in the tracking control circuit 28 are a tracking control module that performs tracking control over the optical pickup 5 based on the tracking servo error signal TE obtained from the tracking servo error detector, and this tracking control module is configured to temporarily set the tracking servo to the OFF state upon switching from the reproduction state to the recording state, measure an offset of the tracking servo error signal TE produced due to this switching, perform offset correction for this offset with respect to the tracking servo error signal, and restore the tracking servo to the ON state after this offset correction.

FIG. 3 shows a structure of the focusing control circuit 26 in detail. This focusing control circuit 26 includes an offset correcting module FCR that performs offset correction with respect to the focusing servo error signal FE from the first differential amplifier 25 and a servo control circuit FSC that generates a servo signal for the focusing actuator 11 based on an output signal from this offset correcting module FCR. The offset correcting module FCR has an AD converter (ADC) 26A that converts the focusing servo error signal FE into a digital form from an analog form and outputs the converted signal to the CPU 31, a DA converter (DAC) 26B that converts an offset correction value from the CPU 31 into an analog form from a digital form to be output as an offset signal, an adder 26C that corrects the focusing servo error signal FE from the first differential amplifier 25 by using the offset signal, and a switch element 26D that selectively outputs the focusing servo error signal FE as a result of this correction based on control of a servo switch signal from the CPU 31. The servo control circuit FSC has an amplifier 26E that amplifies the focusing servo error signal FE from the switch element 26D, a phase compensating module 26F that performs phase compensation with respect to an output signal from this amplifier 26E, and a driver 26G that outputs an output signal from this phase compensating module 26F to the focusing actuator 11 as a servo signal.

That is, the CPU 31 and both the offset correcting module FCR and the servo control circuit FSC in the focusing control circuit 26 constitute a focusing control module that performs focusing control over the optical pickup 5 based on the focusing servo error signal FE obtained from the focusing servo error detector, and this focusing control module is configured to temporarily set the focusing servo to the OFF state upon switching from the reproduction state to the recording state, measure an offset of the focusing servo error signal FE produced due to this switching, perform offset correction for this offset with respect to the focusing servo error signal FE, and restore the focusing servo to the ON state after this offset correction.

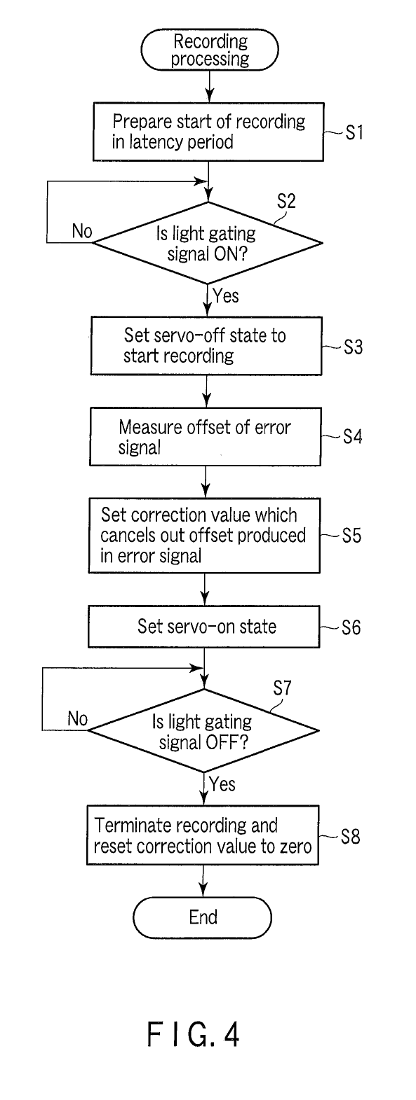

FIG. 4 shows recording processing executed by the CPU 31 when recording data in the optical disk 2 in the optical disk apparatus 1. This recording processing is started in a state where reflected light of a light beam emitted from the optical pickup 5 with a reproduction power and reflected on the recording surface of the optical disk 2 is received, recording track catching on the recording surface of the optical disk 2 and just focusing on this recording surface are achieved, and the tracking servo and the focusing servo are turned on. With start of this recording processing, preparation for start of recording is performed in a latency period as a first block S1. In this preparation, the CPU 31 acquires the tracking servo error signal TE and the focusing servo error signal FE output as numerical values from the AD converters 28A and 26S in a servo-off state, respectively. At a block S2, whether a light gating signal has been turned on to switch the optical disk apparatus 1 from the reproduction state to the recording state is repeatedly checked. The power of the light beam emitted from the optical pickup 5 is changed to a recording power higher than a reproduction power when the light gating signal is turned on. When the fact that the light gating signal has been actually turned on is detected at the block S2, the CPU 31 turns off the switch element 28D of the tracking control circuit 28 and the switch element 26D of the focusing control circuit 26 by using servo switch signals to set the tracking servo and the focusing servo to the OFF state at a block S3, thereby starting recording with respect to the optical disk 2. At a block S4, the CPU 31 respectively acquires the tracking servo error signal TE and the focusing servo error signal FE output as numerical values from the AD converters 28A and 26S in the servo-off state, and measures a difference between a value obtained in the reproduction state and a value obtained in the recording state as an offset of each of the servo error signals TE and FE caused due to switching from the reproduction state to the recording state. At a block S5, the CPU 31 sets a correction value that cancels out the offset of the tracking servo error signal TE in the DA converter 28B, and sets a correction value that cancels out the offset of the focusing servo error signal FE in the DA converter 26B. At a block S6, the CPU 31 uses the servo switch signals to turn on the switch element 28D of the tracking control circuit 28 and the switch element 26D of the focusing control circuit 26, thereby setting the tracking servo and the focusing servo to the ON state. Recording data onto the recording disk 2 is maintained in this state. At a block S7, whether the light gating signal has been turned off is repeatedly checked. The power of the light beam emitted from the optical pickup 5 is changed to a reproduction power when the light gating signal is turned off. When the fact that the light gating signal has been actually turned off is detected, the CPU 31 terminates recording onto the optical disk 2 and resets the correction value to zero.

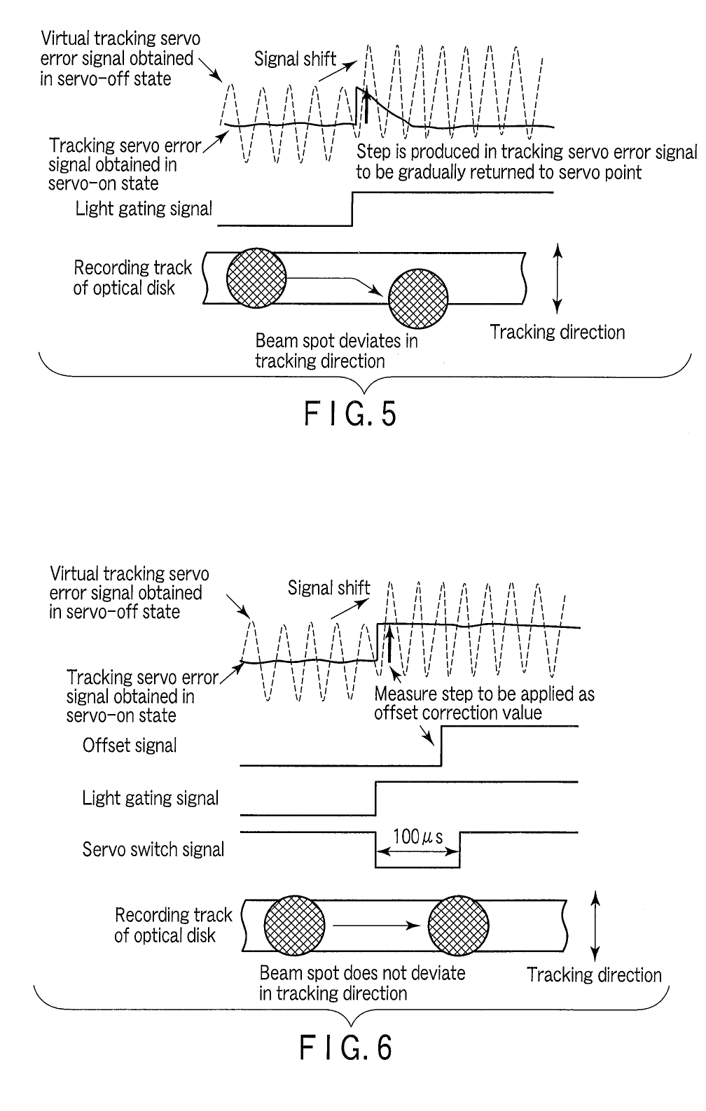

A tracking control operation of the disk apparatus 1 will now be explained. Here, if the offset correcting module TCR is not provided, the tracking servo error signal TE changes as indicated by a solid line in FIG. 5 when the optical disk apparatus 1 is switched from the reproduction state to the recording state. When the light gating signal rises to be turned on, the recording surface of the optical disk 2 is irradiated with a light beam having a recording power higher than a reproduction power. This change in power of the light beam may shift the tracking servo error signal TE because of an influence of signal displacement due to displacement of an optical axis in the optical system of the optical pickup 5, offset displacement of the photodetector 22, or electrical offset displacement of the signal processing system provided at a position following the photodetector 22. That is, a step is produced with respect to a servo point in the reproduction state. When the servo is maintained in this state, the tracking servo error signal TE gradually returns to the servo point based on convergence that is dependent on a response time of the servo system. However, as apparent from a virtual tracking servo error signal TE indicated by a broken line in FIG. 5, the signal shift continues tracking of arranging a beam spot on a position displaced in a tracking direction from the center of the original track to effect recording. Therefore, not only data cannot be recorded at a correct position in the track but also data may be possibly recorded at a wrong position outside the track.

The offset correcting module TCR is provided to maintain the above-explained beam spot in the recording track as shown in FIG. 6. Before the light gating signal rises to be turned on, the optical disk apparatus 1 is in the reproduction state. In this reproductions state, the tracking servo is in the ON state, and the beam spot traces the center of the track. The switch element 28D of the offset correcting module TCR is turned off substantially simultaneously with start of recording involved by rising of the light gating signal. Even if the tracking servo is thereby temporarily turned off, the beam spot can trace the center of the track for a while. The CPU 31 measures an offset (a step) of the tracking servo error signal TE obtained from the AD converter 28A in this state. This step is an unnecessary offset on the tracking servo error signal TE as long as the beam spot is tracing the center of the track. The CPU 31 sets a voltage whose amount is equal to this offset as an offset correction value in the DA converter 28B. When the DA converter 28B subjects this correction value to DA conversion and outputs the converted value as an offset signal to the adder 28C, the adder 28C subtracts the correction value from the tracking servo error signal TE to cancel out the offset and outputs the tracking servo error signal TE as a correction result. Then, the CPU 31 turns on the switch element 28D and supplies the tracking servo error signal TE as the correction result to the servo control circuit TSC. As a result, the center of the virtual tracking servo error signal TE is determined as a servo point, and the tracking servo enters the ON state. Therefore, the beam spot can be likewise maintained at the center of the track in a subsequent process. It is to be noted that, since the power of the light beam is changed from the recording power to the reproduction power with termination of recording, the CPU 31 restores the correction value output to the DA converter 28B to zero.

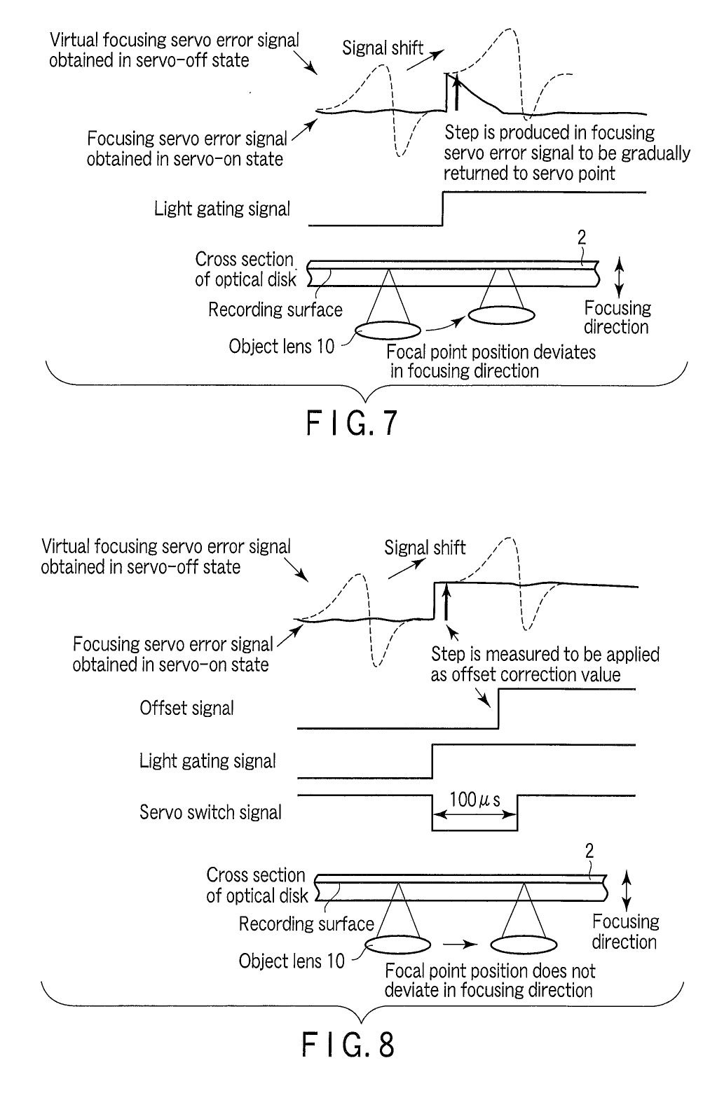

Subsequently, a focusing control operation of the disk apparatus 1 will now be explained. Here, if the offset correcting module FCR is not provided, the focusing servo error signal FE changes as indicated by a solid line in FIG. 7 when the optical disk apparatus 1 is switched from the reproduction state to the recording state. When the light gating signal rises to be turned on as explained above, the recording surface of the optical disk 2 is irradiated with a light beam with a recording power higher than a reproduction power. This change in power of the light beam may shift the focusing servo error signal FE because of an influence of signal displacement due to displacement of an optical axis in the optical system of the optical pickup 5, offset displacement of the photodetector 22, or electrical offset displacement of the signal processing system provided at a position following the photodetector 22. That is, a step is produced with respect to a servo point in the reproduction state. When the servo is maintained in this state, the focusing servo error signal FE gradually returns to the servo point based on convergence that is dependent on a response time of the servo system. However, as apparent from a virtual focusing servo error signal FE indicated by a broken line in FIG. 7, the signal shift continues focusing of arranging a focused focal point (just focusing) position on a position displaced in a focusing direction from the original recording surface to effect recording. Therefore, not only data cannot be recorded with a correct beam spot diameter but also defocusing may possibly occur.

The offset correcting module FCR is provided to maintain the focused focal point position on the recording surface of the optical disk 2 as shown in FIG. 8. Before the light gating signal rises to be turned on, the optical disk apparatus 1 is in the reproduction state. In this reproduction state, the focused focal point position is placed on the recording surface even if the focusing servo is in the ON state. The switch element 26D of the offset correcting module FCR is turned off substantially simultaneously with start of recording involved by rising of the light gating signal, and the focused focal point position is placed on the recording surface for a while even if the focusing servo is temporarily turned off. The CPU 31 measures an offset (a step) of the focusing servo error signal FE obtained from the AD converter 26A in such a state. This step is an unnecessary offset on the focusing servo error signal FE as long as the focused focal point position is placed on the recording surface. The CPU 31 sets a voltage whose amount is equal to this offset as an offset correction value in the DA converter 26B. When the DA converter 26B subjects this correction value to DA conversion and outputs the converted value as an offset signal to the adder 26C, the adder 26C subtracts the correction value from the focusing servo error signal FE to cancel out the offset and outputs the focusing servo error signal FE as a correction result. Then, the CPU 31 turns on the switch element 26D and supplies the focusing servo error signal FE as the correction result to the servo control circuit FSC. As a result, the center of the virtual focusing servo error signal FE is determined as a servo point, and the focusing servo enters the ON state. Therefore, the focused focal point position can be maintained on the recording surface even in a subsequent process. It is to be noted that, since the power of the light beam is changed from the recording power to the reproduction power with termination of recording, the CPU 31 resets the correction value output to the DA converter 26B to zero.

In this embodiment, the tracking servo and the focusing servo are temporarily set to the OFF state upon switching from the reproduction state to the recording state, an offset of the tracking servo error signal TE and an offset of the focusing servo error signal FE caused due to this switching are measured, the offset correction for these offsets is performed with respect to the servo error signals TE and FE, and the tracking servo and the focusing servo are restored to the ON state after this offset correction. That is, since the steps produced in the tracking servo error signal TE and the focusing servo error signal FE due to switching from the reproduction state to the recording state are canceled out by the offset correction, stable servo control can be carried out with respect to the optical pickup 5 in this switching. Incidentally, it is preferable that a period where the tracking servo or the focusing servo is temporarily set to the OFF state upon switching from the reproduction state to the recording state does not exceed 100 μs in order to avoid an erroneous operation.

It is to be noted that the present invention is not restricted to the foregoing embodiment and can be modified in many ways without departing from the scope of the invention.

Although the present invention is applied to both the tracking control and the focusing control in the foregoing embodiment, it may be applied to at least one of them. For example, when the present invention is applied to the tracking control alone, the tracking servo is temporarily set to the OFF state upon switching from the reproduction state to the recording state, an offset of the tracking servo error signal TE caused due to this switching is measured, and the offset correction for this offset is performed with respect to the tracking servo error signal TE, and the tracking servo is restored to the ON state after this offset correction. Furthermore, when the present invention is applied to the focusing control alone, the focusing servo is temporarily set to the OFF state upon switching from the reproduction state to the recording state, an offset of the focusing servo error signal FE caused due to this switching is measured, the offset correction for this offset is performed with respect to the focusing servo error signal, and the focusing servo is restored to the ON state after this offset correction.

Moreover, although the offset correction value is set to a value equal to the offset of each of the tracking servo error signal TE and the focusing servo error signal FE in the foregoing embodiment, it may be set to a value less than the offset. In this case, it is preferable for a percentage of the offset correction value with respect to the offset to increase with repetition of switching from the reproduction state to the recording state. As a result, when, e.g., foreign particles are present on the optical disk 5, their influence can be reduced.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk apparatus comprising:
an optical pickup which irradiates a recording surface of an optical disk with a light beam selectively set to one of a reproduction power and a recording power and receives reflected light from the recording surface; and
a driving module which drives the optical pickup;
wherein the driving module includes an error detector which detects a tracking servo error with respect to a recording track on the recording surface from an output signal of the optical pickup and a tracking control module which performs tracking control over the optical pickup based on a tracking servo error signal obtained from the error detector, and
the tracking control module is configured to temporarily set a tracking servo to an OFF state upon switching from a reproduction state to a recording state, measure an offset of the tracking servo error signal produced due to the switching, perform offset correction for the offset with respect to the tracking servo error signal, and restore the tracking servo to an ON state after the offset correction.

2. The apparatus of claim 1, wherein the tracking control module includes:
an AD converter which converts a tracking servo error signal from the error detector into a digital form from an analog form;
a processing module which measures a difference produced in a numerical value acquired from the AD converter due to switching from the reproduction state to the recording state as the offset and sets a correction value based on a result of the measurement;
a DA converter which converts the correction value set by the processing module into an analog form from a digital form;
an adder which subtracts the correction value obtained from the DA converter from the tracking servo error signal from the error detector to perform the offset correction; and
a switch element which selectively outputs the tracking servo error signal obtained from the adder.

3. The apparatus of claim 2, wherein the optical pickup includes a lens from which the light beam exits and a tracking actuator which changes a position of the lens in a tracking direction crossing the recording track, and
the tracking control module further includes a servo control circuit which generates a servo signal for the tracking actuator based on the tracking servo error signal from the switch element.

4. The apparatus of claim 2, wherein the correction value is set to a value less than the offset.

5. The apparatus of claim 4, wherein a percentage of the correction value with respect to the offset is increased with repetition of switching from the reproduction state to the recording state.

6. The apparatus of claim 2, wherein the correction value is reset to zero with switching from the recording state to the reproduction state.

7. An optical disk apparatus comprising:
an optical pickup which irradiates a recording surface of an optical disk with a light beam selectively set to one of a reproduction power and a recording power and receives reflected light from the recording surface; and
a driving module which drives the optical pickup;
wherein the driving module includes an error detector which detects a focusing servo error with respect to the recording surface from an output signal of the optical pickup and a focusing control module which performs focusing control over the optical pickup based on a focusing servo error signal obtained from the error detector, and
the focusing control module is configured to temporarily set a focusing servo to an OFF state upon switching from a reproduction state to a recording state, measure an offset of the focusing servo error signal produced due to the switching, perform offset correction for the offset with respect to the focusing servo error signal, and restore the focusing servo to an ON state after the offset correction.

8. The apparatus of claim 7, wherein the focusing control module includes:
an AD converter which converts a focusing servo error signal from the error detector into a digital form from an analog form;
a processing module which measures a difference produced in a numerical value acquired from the AD converter due to switching from the reproduction state to the recording state as the offset and sets a correction value based on a result of the measurement;
a DA converter which converts the correction value set by the processing module into an analog form from a digital form;
an adder which subtracts the correction value obtained from the DA converter from the focusing servo error signal from the error detector to perform the offset correction; and
a switch element which selectively outputs the focusing servo error signal obtained from the adder.

9. The apparatus of claim 8, wherein the optical pickup includes a lens from which the light beam exits and a focusing actuator which changes a position of the lens in a focusing direction along an optical axis of the lens, and the focusing control module further includes a servo control circuit which generates a servo signal for the focusing actuator based on the focusing servo error signal from the switch element.

10. The apparatus of claim 8, wherein the correction value is set to a value less than the offset.

11. The apparatus of claim 10, wherein a percentage of the correction value with respect to the offset is increased with repetition of switching from the reproduction state to the recording state.

12. The apparatus of claim 8, wherein the correction value is reset to zero with switching from the recording state to the reproduction state.

13. A servo control method of an optical disk apparatus which comprises an optical pickup which irradiates a recording surface of an optical disk with a light beam selectively set to one of a reproduction power and a recording power and receives reflected light from the recording surface, and a driving module which drives the optical pickup, wherein the driving module includes an error detector which detects a tracking servo error with respect to a recording track on the recording surface and a focusing servo error with respect to the recording surface from an output signal of the optical pickup, and a control module which performs at least one of tracking control and focusing control over the optical pickup based on each servo error signal obtained from the error detector, the method comprising:
temporarily setting a servo to an OFF state upon switching from a reproduction state to a recording state;
measuring an offset of each servo error signal caused due to the switching; performing offset correction for the offset with respect to each servo error signal; and
restoring the servo to an ON state after the offset correction.

14. The method of claim 13, wherein at least one of the tracking control and the focusing control includes:
subjecting the servo error signal to AD conversion from an analog form to a digital form;
measuring a difference produced in a numerical value as a result of the AD conversion due to switching from the reproduction state to the recording state as the offset, and setting a correction value based on a result of the measurement;
subjecting the set correction value to DA conversion from a digital form into an analog form;
subtracting the correction value obtained as a result of the DA conversion from the servo error signal to perform the offset correction; and
selectively outputting the servo error signal obtained by the offset correction.
